(19) United States
(12) Patent Application Publication
(10) Pub. No.: US 2008/0275685 A1
(43) Pub. Date: Nov. 6, 2008

(54) MISS-ACCUMULATION IN A BINARY SPACE PARTITIONING TREE

(76) Inventors: Thomas Michael Gooding, Rochester, MN (US); Kurt Walter Pinnow, Rochester, MN (US); Brian Paul Wallenfelt, Eden Prairie, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/742,919

(22) Filed: May 1, 2007

(51) Int. Cl. G06G 7/58

(52) U.S. Cl. 703/12

(57) ABSTRACT

Embodiments of the invention provide a technique for improving the efficiency of a molecular modeling simulation. In one embodiment, the simulation may parse a kd-tree representing a receptor atom to identify atoms of the receptor within a specified distance of a target point. The target point may represent the center of a spherical envelope enclosing atoms of a ligand atom. A miss-accumulation vector may be used to accumulate a miss distance representing the minimum distance between a target point and a given node of the kd-tree. Thus, although the search algorithm may only evaluate the distance between the target point and a splitting dimension at each node of the kd-tree, the miss-accumulation vector may be used to account for distances over multiple dimensions.

### CROSS-REFERENCE TO RELATED APPLICATIONS

This application is related to U.S. patent application Ser. No. ______, Attorney Docket No. ROC920060208US1, titled “kD Tree and Envelope to Improve Identification of Nearest Atoms,” filed May 1, 2007, by Pinnow, et al.; and U.S. patent application Ser. No. ______, Attorney Docket No. ROC920060210US1, titled “Envelope Technique for Exclusion of Atoms in an Hbond Check,” filed May 1, 2007, by Mullins, et al. These related patent applications are incorporated by reference herein in their entirety.

### BACKGROUND OF THE INVENTION

1. Field of the Invention

The present invention generally relates to computing techniques for modeling physical interactions between two substances at a molecular level. More specifically, the present invention relates to a miss-accumulation technique used to traverse a binary space partitioning tree.

2. Description of the Related Art

Powerful computers may be designed as highly parallel systems where the processing activity of hundreds, if not thousands, of processors (CPUs) are coordinated to perform computing tasks. These systems are highly useful for a broad variety of applications including, financial modeling, hydrodynamics, quantum chemistry and mechanics, astronomy, weather modeling and prediction, geological modeling, prime number factoring, image processing (e.g., CGI animations and rendering), to name but a few examples.

One family of parallel computing systems has been (and continues to be) developed by International Business Machines (IBM) under the name Blue Gene®. The Blue Gene/L architecture provides a scalable, parallel computer that may be configured with a maximum of 65,536 (216) compute nodes. Each compute node includes a single application specific integrated circuit (ASIC) with 2 CPU's and memory. The Blue Gene/L architecture has been successful and on Oct. 27, 2005, IBM announced that a Blue Gene/L system had reached an operational speed of 280.6 teraflops (280.6 trillion floating-point operations per second), making it the fastest computer in the world at that time. Further, as of June 2005, Blue Gene/L installations at various sites world-wide were among five out of the ten top most powerful computers in the world.

IBM is currently developing a successor to the Blue Gene/L system, named Blue Gene/P. Blue Gene/P is expected to be the first computer system to operate at a sustained 1 petaflops (1 quadrillion floating-point operations per second). Like the Blue Gene/L system, the Blue Gene/P system is scalable with a projected maximum of 73,728 compute nodes. Each compute node in Blue Gene/P is projected to include a single application specific integrated circuit (ASIC) with 4 CPU's and memory. A complete Blue Gene/P system is projected to include 72 racks with 32 node boards per rack.

In addition to the Blue Gene architecture developed by IBM, other highly parallel computer systems have been (and are being) developed. For example, a Beowulf cluster may be built from a collection of commodity off-the-shelf personal computers. In a Beowulf cluster, individual systems are connected using local area network technology (e.g., Ethernet) and system software is used to execute programs written for parallel processing on the cluster of individual systems.

As stated, these, and other, parallel systems are often used to perform simulations of molecular systems. One such type of simulation is used to determine whether one compound (referred to as a ligand) will bind to another compound (referred to as a receptor). These simulations are expected to lead to discoveries of new useful drugs and new medical treatment methods. For example, these simulations may be performed to identify a compound that will deliver a particular therapeutic substance to a particular location on a particular protein (e.g., a compound that will target a particular site on the surface of a cancerous cell).

In order to determine whether a compound is likely to bind with a receptor, multiple iterations of a simulation are usually performed to account for the various conformations in which the ligand and receptor may encounter one another. That is, the simulation may evaluate a very large number of possible conformations in which the ligand may bind with the receptor. For each conformation, the simulation may be configured to determine whether the conformation is possible (i.e., likely to occur) and, if so, whether the ligand will bind with the receptor.

Given the nature of this (and other similar) problems, parallel computing has emerged as the preferred way to perform these simulations because a very large number of conformations can be tested simultaneously on the compute nodes of a parallel system. Of course, molecular simulations may be performed on more conventional computer systems; they just take significantly longer to perform.

As stated, these types of molecular simulations may first evaluate whether a given receptor/ligand conformation is physically possible. For example, a conformation may position an atom from the ligand at a point too close to an atom in the receptor. That is, the conformation may specify a state for the ligand and receptor that cannot (or is highly unlikely) to occur in the real world, based on our understanding of quantum mechanics. If the atoms are too close, then the results of any free energy calculations based on that conformation are unlikely to produce any meaningful data.

Traditionally, a brute force method is used to ensure that none of the ligand atoms are too close to the receptor atoms. That is, the simulation checks all n atoms of the ligand against all m atoms of the receptor. This leads to a runtime requirement of m*n comparisons for a single conformation. And recall, this process is usually performed for many thousands of different confirmations between a ligand and receptor, and performed for hundreds of ligands (if not thousands or more). As a result, the performance cost of performing an n*m comparison for each conformation is magnified many times. Commonly assigned patent application “Envelope Technique for Exclusion of Atoms in an Hbond Check” (Atty. docket ROC-9-2006-0210) describes an improvement to this technique where only atoms within a defined region of space are selected for comparison. However, once the envelope is identified, which atoms of the receptor are within the envelope may have to be determined using a brute force approach. That is, each atom of the receptor may have to be evaluated to determine whether it is inside or outside of the envelope.

An alternative approach is to represent the positions of the atoms of the ligand and receptor in a kd-tree. This approach allows searches to be performed that will identify all atoms within a certain distance of a target point in order log(n) time. Generally, a kd-tree may be searched by comparing the location of the target point to the location of the atom at a given node in a particular dimension. If the location of the target point is greater than the node atom in that dimension, then the right sub-tree is searched. Conversely, if the location of the target point is less than the node in that dimension, then the left sub-tree is searched. Thus, at each node, the search progresses by moving closer to the target in a different dimension at each level of the tree.

When searching for all atoms within a specified distance of the target location, however, the “other” sub-tree still needs to be searched when the distance between an atom's position in a given dimension and the location of the target point is not greater than the specified distance to search within. This is necessary because there could still be nodes representing atoms within the specified distance, even though they are on the branch of the kd-tree further away from the target point (in the dimension of the kd-tree at that level). This result increases the number of recursive calls to the search function, thereby degrading simulation performance and efficiency.

Accordingly, as the foregoing illustrates, there remains a need for improvements in the techniques used to perform these (and other similar) types of molecular modeling simulations.

### SUMMARY OF THE INVENTION

Embodiments of the present invention may improve the performance of a computational simulation by using a miss-accumulation technique that may substantially reduce the number of recursive calls required for traversing a binary space partitioning tree.

One embodiment of the invention provides a method of performing a computational simulation. The method generally includes searching a first kd-tree storing the positions of atoms in a first molecule in order to identify atoms of the first molecule that are within an envelope surrounding a set of atoms in a second molecule. The searching step may include, recursively, traversing the first kd-tree to a next node of the first kd-tree, and upon determining that a first distance between the node and a target point is less than a specified maximum distance, adding the node to a result set. The searching step may also include determining a second distance, in a splitting dimension, between a dimensional coordinate of the node and a dimensional coordinate of the target point. Upon determining that the second distance is less than the maximum distance, the second distance may be added to a miss-accumulation vector. The miss-accumulation vector stores a minimum distance between the target point and nodes in sub-branches of the node across all k-dimensions of the first kd-tree. Upon determining that a distance between the miss-accumulation vector and the target point is greater than the maximum distance, only a branch of the first kd-tree closer to the target point in the splitting dimension is searched. Otherwise, both the left-sub branch and the right sub-branch of the first kd-tree are searched. If the second distance is greater than the maximum distance, only the branch of the first kd-tree closer to the target point in the splitting dimension is searched.

Another embodiment of the invention includes a computer-readable storage medium containing a program which, when executed, performs an operation for performing a computational simulation. The operation may include searching a first kd-tree storing positions of atoms in a first molecule to identify which atoms of the first molecule are within an envelope surrounding a set of atoms in a second molecule. The searching operation may include, recursively, traversing the first kd-tree to a next node of the first kd-tree, and upon determining that a first distance between the node and a target point is less than a specified maximum distance, adding the node to a result set. The searching operation may also include determining a second distance, in a splitting dimension, between a dimensional coordinate of the node and a dimensional coordinate of the target point. Upon determining that the second distance is less than the maximum distance, the second distance is added to a miss-accumulation vector, wherein the miss-accumulation vector stores a minimum distance between the target point and nodes in sub-branches of the node across all k-dimensions of the first kd-tree. Upon determining that a distance between the miss-accumulation vector and the target point is greater than the maximum distance, only a branch of the first kd-tree closer to the target point in the splitting dimension is searched, otherwise, both the left-sub branch and the right sub-branch of the first kd-tree is searched. Upon determining that the second distance is greater than the maximum distance, the branch of the first kd-tree closer to the target point in the splitting dimension is searched.

Another embodiment of the invention is a computing device that includes a compute node having at least a processer and a memory and a simulation program, which when executed by the compute node, performs an operation. The operation may include searching a first kd-tree storing positions of atoms in a first molecule to identify which atoms of the first molecule are within an envelope surrounding a set of atoms in a second molecule. The searching operation may include, recursively, traversing the first kd-tree to a next node of the first kd-tree, and upon determining that a first distance between the node and a target point is less than a specified maximum distance, adding the node to a result set. The searching operation may also include determining a second distance, in a splitting dimension, between a dimensional coordinate of the node and a dimensional coordinate of the target point. Upon determining that the second distance is less than the maximum distance, the second distance is added to a miss-accumulation vector, wherein the miss-accumulation vector stores a minimum distance between the target point and nodes in sub-branches of the node across all k-dimensions of the first kd-tree. Upon determining that a distance between the miss-accumulation vector and the target point is greater than the maximum distance, only a branch of the first kd-tree closer to the target point in the splitting dimension is searched, otherwise, both the left-sub branch and the right sub-branch of the first kd-tree is searched. Upon determining that the second distance is greater than the maximum distance, the branch of the first kd-tree closer to the target point in the splitting dimension is searched.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level block diagram of components of a massively parallel computer system, according to one embodiment of the present invention.

FIG. 2 is a high-level diagram of a compute node of the system of FIG. 1, according to one embodiment of the invention.

FIG. 3 is a conceptual illustration of a computing cluster, according to one embodiment of the invention.

FIG. 4 illustrates an example of a kd-tree generated for a set of two-dimensional coordinates.

FIG. 5 illustrates a method for performing a computational simulation using a kd-tree and envelope to improve identification of nearest atoms, according to one embodiment of the invention.

FIG. 6 illustrates a method for performing a computational simulation configured to parse a kd-tree to identify atoms of a receptor molecule within a spherical envelope using a miss-accumulation technique, according to one embodiment of the invention.

FIG. 7 illustrates a geometric representation of the kd-tree shown in FIG. 4 being searched using the miss-accumulation method illustrated in FIG. 6.

### DETAILED DESCRIPTION OF THE PREFERRED EMBODIMENTS

Embodiments of the invention provide a technique for improving the efficiency of a molecular modeling simulation. For example, embodiments of the invention may be used to reduce the number of recursive calls made to a search function configured to parse a binary space partition tree. Typically, the simulation stores the relative position of atoms in a three-dimensional kd-tree, where each node of the kd-tree identifies a three-dimensional (3D) coordinate position of one of the atoms in the simulation. As is known, a kd-tree is a multidimensional binary search tree for points in a k dimensional space. For example, a two-dimensional (2D) kd-tree may be used to partition a 2D plane into a set of rectangles, and a 3D kd-tree may be used to partition a three dimensional space into a collection of 3D regions (commonly referred to as hyperrectangles).

In one embodiment, the simulation may parse a kd-tree representing a receptor atom to identify atoms of the receptor within a specified distance of a target point. The target point may represent the center of a spherical envelope enclosing atoms of a ligand atom. A miss-accumulation vector may be used to accumulate a miss distance representing the minimum distance between a target point and a given node of the kd-tree. Thus, although the search algorithm may only evaluate the distance between the target point and a splitting dimension at each node of the kd-tree, the miss-accumulation vector may be used to account for distances over multiple dimensions. In one embodiment, the miss-accumulation function may be configured to accumulate the distances in each dimension and used to calculate a minimum Euclidian distance for the branch of the tree further from the target point. If the accumulated miss distance at a given node is greater than the specified maximum distance from the target point, then a search of that entire sub-tree of that node may be avoided, even though the distance in the dimension may be less than the specified distance. Because molecular modeling simulations are typically performed a very large number of times for different conformations of even a single ligand and receptor, the effect of reducing the average number of recursive calls to the search function for any individual conformation is highly leveraged and can provide a significant improvement to overall simulation performance

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM or DVD-ROM disks readable by a CD- or DVD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

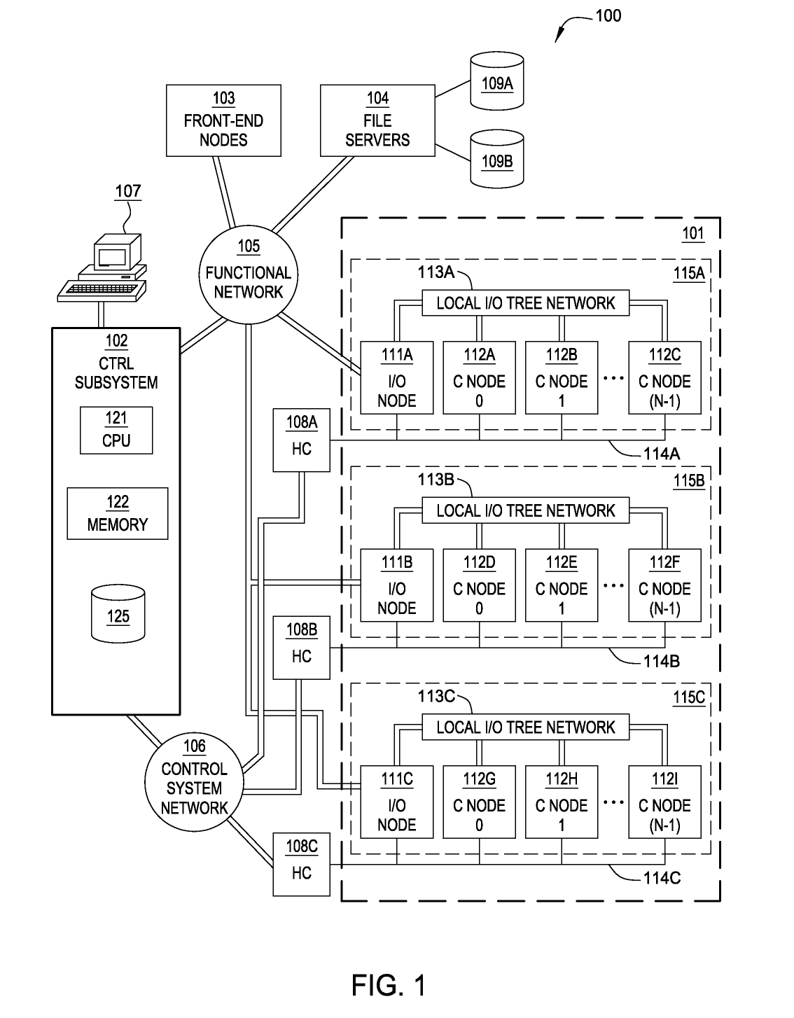

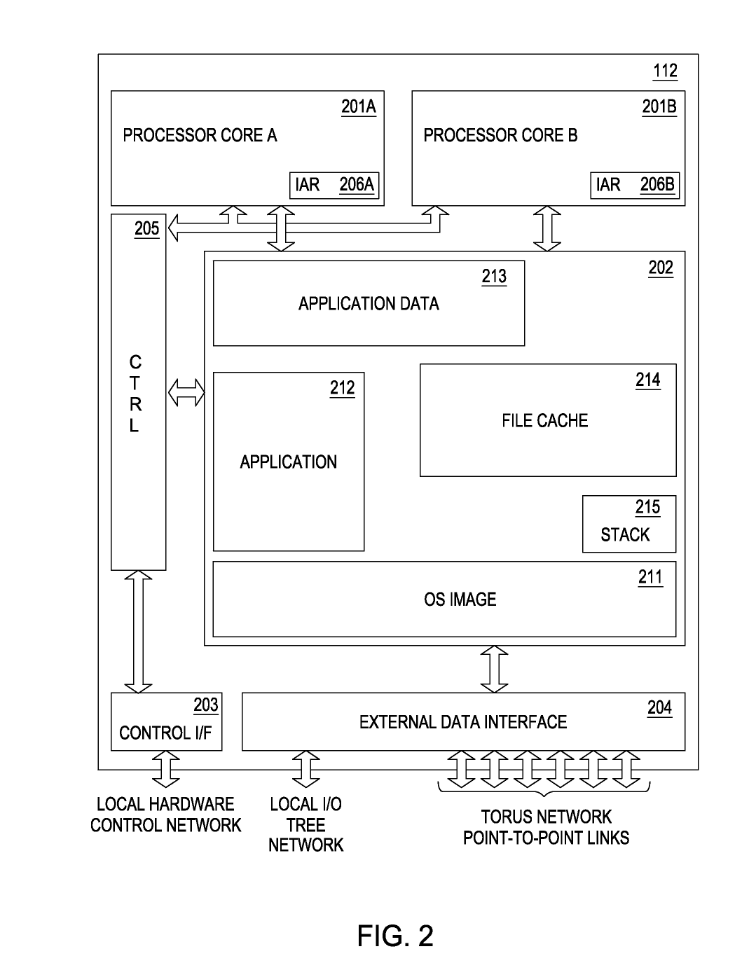

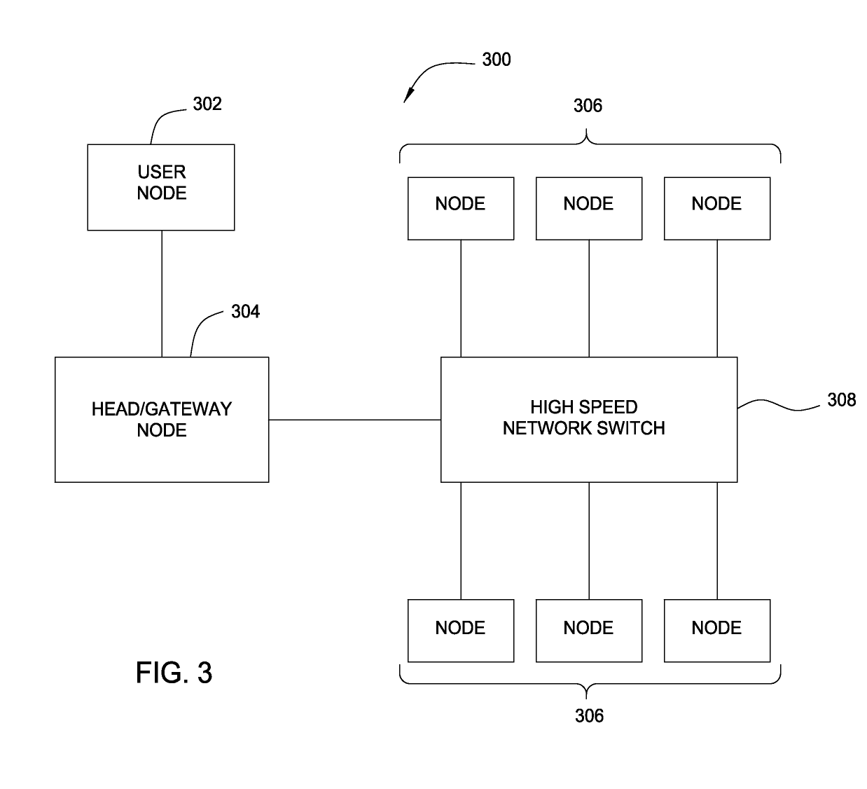

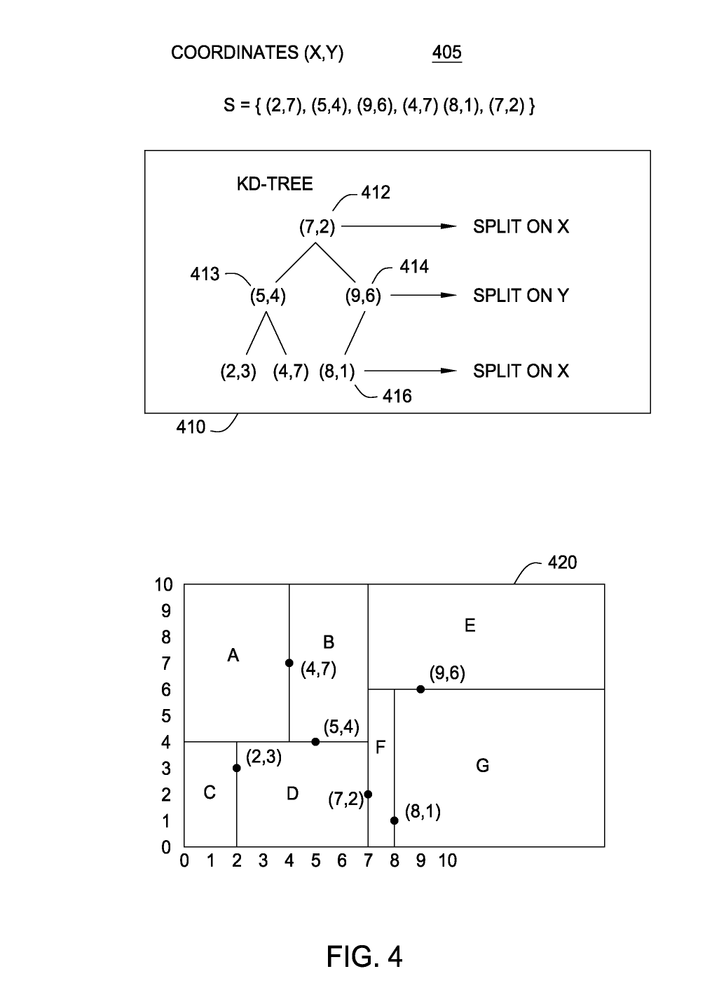

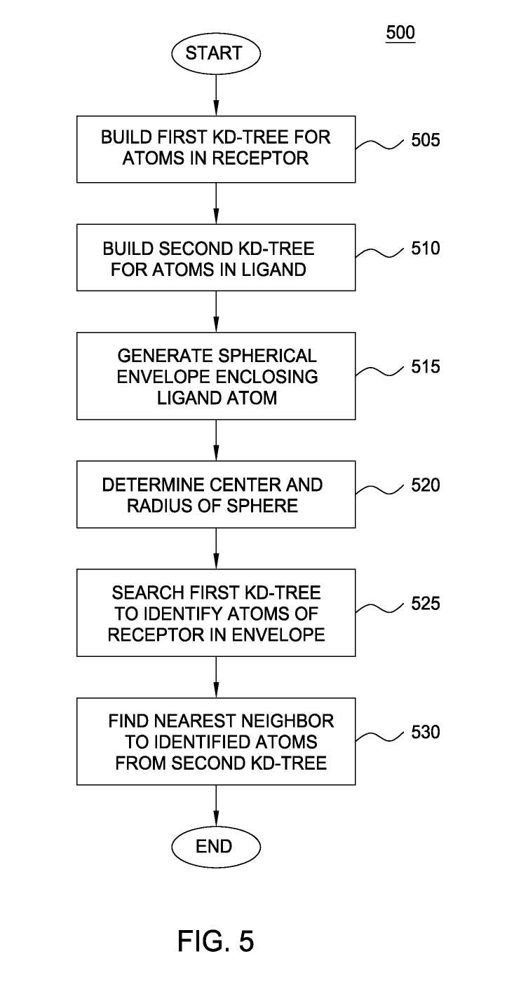

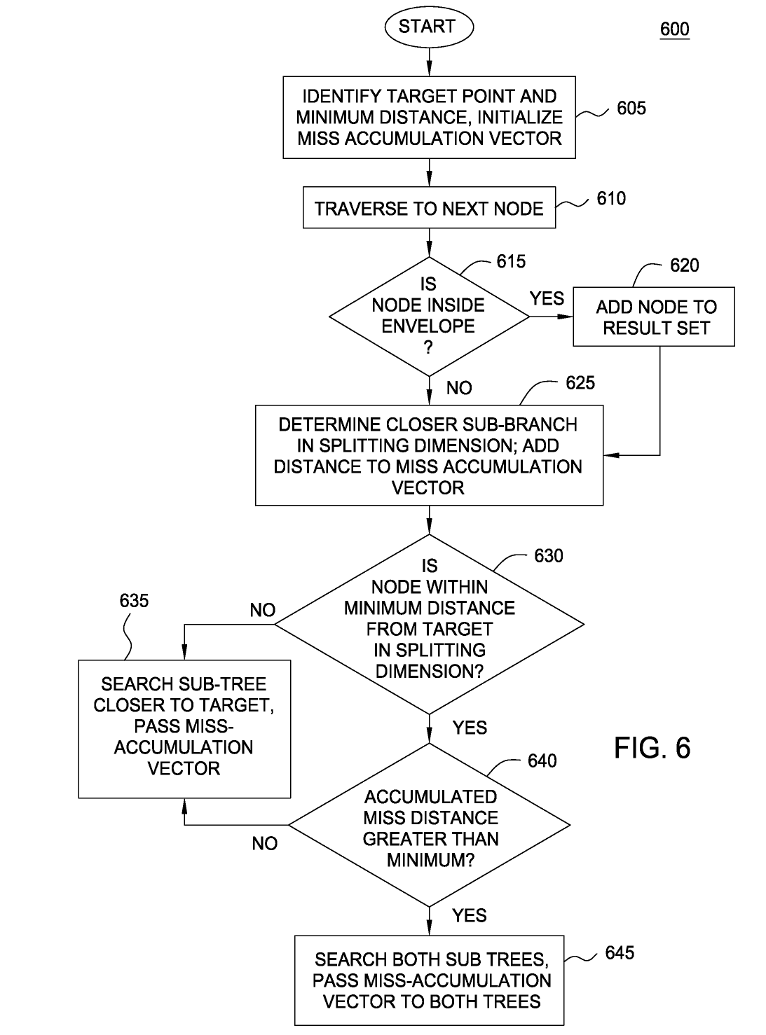

Embodiments of the invention are well suited for use with highly-parallel computer systems, such as the Blue Gene system developed by IBM. Accordingly, FIGS. 1-2 describe the general architecture of a Blue Gene system. And FIG. 3 illustrates the general architecture of a Beowulf computing cluster, which provides an additional example of a parallel computing architecture. FIG. 4 provides an example kd-tree generated for a set of coordinate positions. FIGS. 5 and 6 illustrate methods for using a miss-accumulation technique in a computational simulation

FIG. 1 is a high-level block diagram of components of a massively parallel computer system 100, according to one embodiment of the invention. Illustratively, computer system 100 shows the high-level architecture of an IBM Blue Gene® computer system, it being understood that other parallel computer systems could be used, and the description of this architecture is not intended to limit the present invention.

As shown, computer system 100 includes a compute core 101 having a number of compute nodes arranged in a regular array or matrix, which perform the useful work performed by system 100. The operation of computer system 100, including compute core 101, may be controlled by control subsystem 102. Various additional processors in front-end nodes 103 may perform auxiliary data processing functions and file servers 104 provide an interface to data storage devices such as disk based storage 109A and 109B or other I/O (not shown). Functional network 105 provides the primary data communication path among compute core 101 and other system components. For example, data stored in storage devices attached to file servers 104 is loaded and stored to other system components through functional network 105.

Also as shown, compute core 101 includes I/O nodes 111A-C and compute nodes 112A-I. Compute nodes 112 provide the processing capacity of parallel system 100, and are configured to execute applications written for parallel processing. I/O nodes 111 handle I/O operations on behalf of compute nodes 112. Each I/O node 111 may include a processor and interface hardware that handles I/O operations for a set of q compute nodes 112, the I/O node and its respective set of q compute nodes are referred to as a Pset. Compute core 101 contains p Psets 115A-C, each including a single I/O node 111 and q compute nodes 112, for a total of p×q compute nodes 112. The product p×q can be very large. For example, in one implementation p=1024 (1K) and q=64, for a total of 64K compute nodes.

In general, application programming code and other data input required by compute core 101 to execute user applications, as well as data output produced by the compute core 101, is communicated over functional network 105. The compute nodes within a Pset 115 communicate with the corresponding I/O node over a corresponding local I/O tree network 113A-C. The I/O nodes, in turn, are connected to functional network 105, over which they communicate with I/O devices attached to file servers 104, or with other system components. Thus, the local I/O tree networks 113 may be viewed logically as extensions of functional network 105, and like functional network 105 are used for data I/O, although they are physically separated from functional network 105.

Control subsystem 102 directs the operation of the compute nodes 112 in compute core 101. Control subsystem 102 is a computer that includes a processor (or processors) 121, internal memory 122, and local storage 125. An attached console 107 may be used by a system administrator or similar person. Control subsystem 102 may also include an internal database which maintains state information for the compute nodes in core 101, and an application which may be configured to, among other things, control the allocation of hardware in compute core 101, direct the loading of data on compute nodes 111, and perform diagnostic and maintenance functions.

Control subsystem 102 communicates control and state information with the nodes of compute core 101 over control system network 106. Network 106 is coupled to a set of hardware controllers 108A-C. Each hardware controller communicates with the nodes of a respective Pset 115 over a corresponding local hardware control network 114A-C. The hardware controllers 108 and local hardware control networks 114 are logically an extension of control system network 106, although physically separate.

In addition to control subsystem 102, front-end nodes 103 provide computer systems used to perform auxiliary functions which, for efficiency or otherwise, are best performed outside compute core 101. Functions which involve substantial I/O operations are generally performed in the front-end nodes. For example, interactive data input, application code editing, or other user interface functions are generally handled by front-end nodes 103, as is application code compilation. Front-end nodes 103 are connected to functional network 105 and may communicate with file servers 104. In one embodiment, compute nodes 112 are arranged logically in a three-dimensional torus, where each compute node may be identified using an x, y and z coordinate.

FIG. 2 is a high-level diagram of a compute node 112 of the system 100 of FIG. 1, according to one embodiment of the invention. As shown, compute node 112 includes processor cores 201A and 201B, and also includes memory 202 used by both processor cores 201; an external control interface 203 which is coupled to local hardware control network 114; an external data communications interface 204 which is coupled to the corresponding local I/O tree network 113, and the corresponding six node-to-node links of the torus network; and monitoring and control logic 205 which receives and responds to control commands received through external control interface 203. Monitoring and control logic 205 may access processor cores 201 and locations in memory 202 on behalf of control subsystem 102 to read (or in some cases alter) the operational state of node 112. In one embodiment, each node 112 may be physically implemented as a single, discrete integrated circuit chip.

As described, functional network 105 may service many I/O nodes, and each I/O node is shared by multiple compute nodes 112. Thus, it is apparent that the I/O resources of parallel system 100 are relatively sparse when compared to computing resources. Although it is a general purpose computing machine, parallel system 100 is designed for maximum efficiency in applications which are computationally intense.

As shown in FIG. 2, memory 202 stores an operating system image 211, an application code image 212, and user application data structures 213 as required. Some portion of memory 202 may be allocated as a file cache 214, i.e., a cache of data read from or to be written to an I/O file. Operating system image 211 provides a copy of a simplified-function operating system running on compute node 112. Operating system image 211 may includes a minimal set of functions required to support operation of the compute node 112. In a Blue Gene system, for example, operating system image 211 contains a version of the Linux® operating system customized to run on compute node 112. Of course, other operating systems may be used, and further it is not necessary that all nodes employ the same operating system. (Also note, Linux® is a registered trademark of Linus Torvalds in the United States and other countries.)

Application code image 212 represents a copy of the application code being executed by compute node 112. Application code image 212 may include a copy of a computer program being executed by parallel system 100, but where the program is very large and complex, it may be subdivided into portions which are executed by different compute nodes 112. For example, Application code image 212 may include a sequence of instructions which, when executed by compute node 112, perform an operation for performing computational simulation. The simulation may include the use of a kd-tree and envelope to improve identification of nearest atoms as part of the computational simulation. In such a case, when performed essentially simultaneously by as many as 65,536 compute nodes of parallel system 100, a vast number of possible conformations between a ligand and a receptor may be evaluated. Memory 202 may also include a call-return stack 215 for storing the states of procedures which must be returned to, which is shown separate from application code image 202, although it may be considered part of application code state data.

As part of ongoing operations, application 212 may transmit messages from compute node 112 to other compute nodes in parallel system 100. For example, the high level MPI call of MPI_Send( ); may be used by application 312 to transmit a message from one compute node to another. On the other side of the communication, the receiving node may call use the MPI call MPI_Recieve( ); to receive and process the message. In context of the present invention, for example, a message may be sent from a control node to a compute node describing a conformation of a ligand and receptor to be evaluated by the receiving node. The receiving node may perform the simulation and then generate and transmit a message back regarding the results.

Other parallel systems also include a mechanism for transmitting messages between different compute nodes. For example, nodes in a Beowulf cluster may communicate using a using a high-speed Ethernet style network. FIG. 3 illustrates the high level architecture of a Beowulf cluster, according to one embodiment of the invention. It being understood that other parallel computer systems could be used, and the description of this architecture is not intended to limit the present invention.

FIG. 3 illustrates another example of a parallel architecture, according to one embodiment of the invention. Cluster 300 is representative of a Beowulf cluster, as well as other clustering architectures. As shown, cluster 300 includes a user node 302, gateway node 304, and compute nodes 306 connected via high-speed network switch 308. Those skilled in the art will recognize that FIG. 3 provides a simplified representation of a computing cluster, and that the nodes of a typical computing cluster include a number of additional elements.

User node 302 may provide an interface to cluster 300. As such, user node 302 allows users to create, submit, and review the results of computing tasks submitted for execution to cluster 300. As shown, user node 302 is connected to head/gateway node 304. Head/gateway node 304 connects the user node 302 to the compute nodes 306. Compute nodes 306 provide the processing power of cluster 300. As is known, clusters are often built from racks of commonly available PC components. Thus, each node 306 may include one or more CPUs, memory, hard disk storage, a connection to high speed network switch 308, and other common PC components. Like the compute nodes 112 of parallel system 100, a compute node 306 of cluster 300 may execute a molecular modeling simulation evaluating a conformation of a ligand and a receptor.

FIG. 4 illustrates an example of a kd-tree generated for a set 405 of two-dimensional coordinates. Illustratively, set 405 includes six coordinate pairs: {(2, 3), (5, 4), (9, 6), (4, 7), (8,1), (7, 2)}. The coordinates in set 405 are used to generate the example kd-tree 410 shown in FIG. 4. As stated, a kd-tree is a multidimensional binary search tree for points in a k dimensional space. For example, a 3D kd-tree may be used to partition a two dimensional plane into a set of rectangles, and a 3D kd-tree may be used to partition a 3D space into a collection of 3D regions (commonly referred to as hyperrectangles). However, for simplicity, the examples provided herein are illustrated using a 2D kd-tree.

Each node in a kd-tree includes a pointer to a node of a left branch and a pointer to a node of a right branch, each branch forming a kd-tree. Levels of the tree are split along successive k dimensions. For example, for a two-dimensional kd-tree, the tree may first be split using the x-dimension, then the y-dimension, then the x-dimension, then the y-dimension, and so forth. For a three-dimensional kd-tree the tree may be split, first in the x-dimension, then the y-dimension, then the z-dimension, and so forth. From an individual node in the kd-tree, the left branch contains values less than the value in that node (for the splitting dimension on that level), and the right branch contains values greater than the value in that node (for the splitting dimension on that level).

kd-tree 410 illustrates an example of a kd-tree generated from the coordinate pairs in set 405. In this case, the point (7, 2) is at a root node 412 of kd-tree 410. kd-tree 410 is split at the this level on the x-dimension. Thus, the left branch from root node 412 includes nodes with an x value less than that of the root node 412. And the right branch from root node 412 includes nodes with an x value greater than that of the root node 412. The next level of kd-tree 410 includes nodes 413 and 414. The two nodes on this level are split in the y-dimension. Thus, the tree to the right of the node 413 includes nodes with y values greater than that of the node 413 and the tree to the right of the node 413 includes nodes with y values greater than that of node 413. Similarly, the sub-tree to the left of node 414 (namely, node 416) includes nodes with y values greater than that of node 414. On the next level, splitting returns to the x-dimensions, and a left branch and right branch may split the x-dimension for these nodes. In the example kd-tree 410, however, no further nodes are present.

FIG. 4 also shows a geometric representation of kd-tree 410. Specifically, graph 420 shows the partitioning of a two-dimensional plane based on kd-tree 410. As shown, the vertical line containing the point (7, 2) (corresponding to root node 412) splits the plane in the x-dimension for the value x=7. That is, the plane includes two regions, one with x values less than 7 (regions A, B, C, and D), and one with x values greater than 7 (regions E, F, and G). The next level splits the two regions created by the root node along the y-dimension. On the left side, node 413 (the point 5, 4)) is used to further split the left region into two sub-regions, one with y values less than 4 (regions C and D), and one with y values greater than 4 (regions A and B). On the right side of node 412, node 414 (the point (9, 6)) is used to further split the right region into two sub-regions, one with y values less than 6 (regions F and G), and one with y values greater than 4 (region E). Because this example illustrates a two-dimensional kd-tree, the next level returns to splitting in the x-dimension, as can be seen on the vertical lines passing through nodes (2, 3), (4, 7), and (8, 1). Each of these vertical further partitions the plane based on the x values for one of the points in the third level of kd-tree 410. Thus, as can be seen, each split creates a successively smaller rectangular partition of the plane. However, for a three dimensional tree, the next splitting dimension would be in the z dimension, and each split would further partition a three dimensional volume into smaller and smaller three-dimensional hyperrectanlges.

In one embodiment, a computational simulation of a conformation for a ligand and receptor stores the physical location (e.g., an (x, y, z) coordinate) for each atom in the ligand and each atom in the receptor as nodes in three-dimensional kd-trees. The resulting kd-tree structures may be used to:

find the nearest atom to any point in a three-dimensional space

find the nearest n atoms

find all atoms within a certain distance

find one atom within a certain distance.

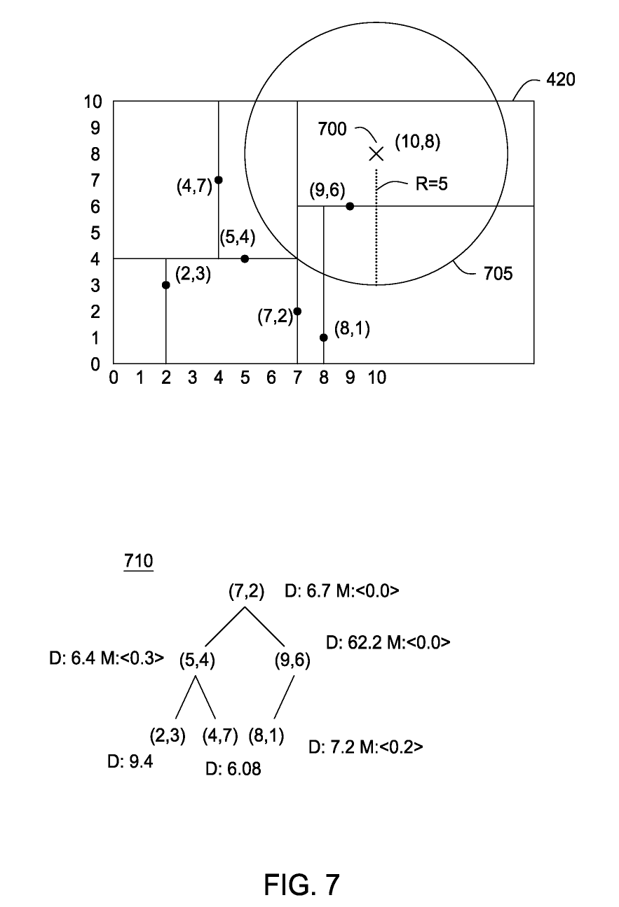

Moreover, each of these functions may be performed more efficiently than through the use of brute-force techniques. For example, FIG. 5 illustrates a method for using a kd-tree and envelope to improve identification of nearest atoms as part of a computational simulation. FIG. 6 illustrates a method for using a miss-accumulation technique in a binary space partitioning tree (e.g., a kd-tree) to improve identification of nearest atoms as part of a computational simulation. FIG. 7 provides an example of the miss-accumulation technique shown in FIG. 6 being used to parse and evaluate the kd-tree illustrated in FIG. 4.

FIG. 5 illustrates a method for performing a computational simulation using a kd-tree and envelope to improve identification of nearest atoms, according to one embodiment of the invention. The method 500 may be performed by multiple compute nodes of a parallel computer system, like the ones illustrated in FIGS. 1-3, as part of a computational simulation to analyze binding affinity between a ligand and a receptor. Of course, one of ordinary skill in the art will recognize that the method 500 may be adapted for use on other parallel computer systems, distributed processing networks, or other non-parallel computer systems.

As shown, the method 500 begins at step 505 where a first kd-tree is built to represent the physical positions of atoms in a receptor molecule. At step 510 a second kd-tree is generated to represent the physical positions of atoms in a ligand molecule. The relative positions of the receptor and ligand may be evaluated to determine whether any atom of one is too close to any atom in the other, for a given conformation. For example, the Lennard-Jones potential between the two atoms may be calculated. If the atoms are too close, then the conformation may be discarded from further evaluation.

At step 515, a spherical envelope may be generated. In one embodiment, the spherical envelope defines a region of space that encloses the atoms present in the ligand. As described in commonly assigned patent application “Envelope Technique for Exclusion of Atoms in an Hbond Check” (atty. docket ROC-9-2006-0210), the atoms in the ligand are usually distributed more compactly and may therefore be easier to define an envelope around than the atoms in a receptor, which is often much larger than the ligand. In various embodiments, the spherical envelope may be based on the center of mass of the ligand or on a geometric center of the ligand.

At step 520, the simulation may be configured to determine the position of the center of the spherical envelope and the radius of the spherical envelope. For example, the radius may equal the distance from the center of mass (or geometric center) of the ligand to the atom of the ligand furthest away from the center. Additionally, in one embodiment, the size of the envelope may be enlarged by an amount representing a distance over which hydrogen bonding interactions are expected to occur between the ligand and the receptor (typically a few angstroms).

At step 525, the simulation may search the first kd-tree (representing the positions of atoms in the receptor) to identify atoms of the receptor within the envelope. That is, the simulation may parse the first kd-tree to find all atoms of the receptor with a distance to the center of the spherical envelope smaller than the radius of the spherical envelope. FIG. 6, described below, illustrates a method for identifying atoms of the receptor within the envelope using a miss-accumulation technique.

At step 530, which atoms in the ligand are nearest to atoms of the receptor identified at step 525 may be determined. For example, for each atom of the receptor within the envelope, a molecular modeling simulation may be configured to parse the kd-tree storing the positions of atoms in ligand and efficiently identify the nearest atom of the ligand. Further examples of identifying the atom of the ligand nearest to an atom of the receptor are described in commonly assigned application titled “kd-Tree and Envelope to Improve Identification of Nearest Atoms,” which is herein incorporated by reference in its entirety.

FIG. 6 illustrates a method for performing a computational simulation configured to parse a kd-tree to efficiently identify atoms of a receptor molecule within an envelope using a miss-accumulation technique, according to one embodiment of the invention. As shown, method 600 begins at step 605 where a molecular modeling simulation identifies a target point, a minimum distance from that target point, and initializes a miss-accumulation vector. For example, the target point may be the center of the spherical envelope and the minimum distance may be the radius of the envelope. In one embodiment, the miss-accumulation vector may be initialized to <0, 0, 0> meaning that at the root of the kd-tree, no miss-accumulation distance has been accumulated into the vector. As the miss-accumulation vector is passed to sub-nodes, the miss distance at each level is added to the miss-accumulation vector.

At step 610, the search function may traverse to the next node of the tree, initially the root node. At step 615, the simulation determines whether the current node is inside the envelope. For example, the simulation may calculate the Euclidean distance from the current node to the target point. If that distance is smaller than the radius of the envelope, then the node is added to a result set (step 620). The result set stores each node of the receptor within the envelope, as determined using method 600.

At step 625, the simulation may determine which sub-branch of the kd-tree is closer to the target point, for the splitting dimension of the kd-tree at that level. This distance may then be added to the miss-accumulation vector. For the tree representing three dimensional coordinate positions of receptor atoms, for example, the kd-tree cycles through splitting on the x, y, and z dimensions. Thus, at each level, the simulation may traverse the tree by evaluating the sub-branch of the tree that is closer to the target point (in the splitting dimension). However, if the sub-branch that is farther from the target in the splitting dimension is within the minimum distance, that sub-branch may also need to be searched.

Accordingly, at step 630, the simulation may determine if the current node is within the minimum distance from the target point in the splitting dimension. If not, then at step 635, the only the sub-branch closer to the target point is searched. However, if the distance from the target point to the current node (in the splitting dimension) is less than the specified minimum, then at step 640, the simulation may determine whether the accumulated miss distances is greater than the specified minimum. If so, in one embodiment, searching the farther sub-branch is omitted if the miss-accumulation distance is greater than the specified minimum distance.

If both (i) the distance between the current node and the target point and (ii) the distance between the miss-accumulation vector and the target point are less than the minimum distance, then at step 645, both sub-branches of the kd-tree are searched.

In one embodiment, the sub-branch with values that increase the distance from the target point in the splitting dimension is passed the miss-accumulation vector with the distance to the target point (in the splitting dimension) added to the miss-accumulation vector. And the branch that moves closer to the target point in the splitting dimension is passed the miss-accumulation vector without the distance in the splitting dimension added at that level. This makes sense, as all nodes in the sub-branch that move away from the target point (in the splitting dimension) will have at least the distance between target point and that node, even though the positions of sub-branch nodes may move closer in other dimensions.

FIG. 7 illustrates a geometric representation of the kd-tree shown in FIG. 4 being searched using the miss-accumulation method illustrated in FIG. 6. In this example, kd-tree 410 is searched to identify all points within five units of a target point 700 of (10, 8), as shown by circle 705. Initially, the search begins at the root node (7, 2) which splits kd-tree 710 in the x-dimension. The point (7, 2) has a distance of 6.7 units away from target point 700 of (10, 8), thus, the point (7, 2) is outside of the envelope defined by a sphere with a radius of five centered at (10, 8). Accordingly, the point (7, 2) is not added to a result set.

In the splitting dimension of kd-tree 710 at this level (i.e., the x-dimension), the point (7, 2) is three units away from the target point of (10, 8). Because this distance is within the specified distance of 5 units, both sub-branches may be searched. Further, because the miss-accumulation vector is currently <0, 0> both branches are searched in this example. Nodes in the left branch are all further away from the target point (in the x-dimension). Thus, this branch may be searched with a miss-accumulation vector of <3, 0>. This is because by virtue of the design of a kd-tree all nodes in the left sub-branch are guaranteed to be less than 7 in the x-dimension (i.e., all nodes are guaranteed to have a distance greater than three in the x-dimension). For the sub-branch to the right of the root node (7, 2) the miss-accumulation vector remains <0, 0>.

Next, the next level of kd-tree 710 is searched. On this level of kd-tree 710, values are split across the y-dimension. As stated, in our example, both sub-branches are searched. Accordingly, points (5, 4) and (9, 6) are evaluated.

For the left branch from the root node (7, 2), the sub-branch splits on the value of y=4. The point (5, 4) has a distance of 6.4 units away from this target point (10, 8), thus, the point (5, 4) is outside of the envelope defined by a sphere with a radius of five centered at (10, 8). Accordingly, the point (5, 4) is not added to a result set. Additionally, in the y-dimension, this node is 4 units away from the target point of (10, 8). Thus, conventionally, both sub branches of the tree would need to be searched. In one embodiment, however, before searching the left sub-branch, the distance from this node to the target point in the y-dimension is added to the miss-accumulation vector, giving a miss-accumulation vector of <3, 4>. Thus, the accumulated miss distance is 5 units away from the search of (10, 8), and further, the distance of 5 units defines a minimum distance for both this point (5, 4) and all points below this point in the left sub-branch of kd-tree 410. Accordingly, the entire left sub-branch beginning at the point (5, 4) need not be evaluated. The right sub-branch beginning from the point (5, 4) still needs to be searched with a miss-accumulation vector of (3, 0). Specifically, the node (4, 7) is evaluated. Because this node is 6.08 units away from the target point, it is not included in the result set.

For the left branch from the root node (7, 2), the sub-branch splits on the value of y=6. The point (9, 6) has a distance of 2.2 units away from the target point 700, thus, the point (9, 6) is inside of the envelope defined by a sphere with a radius of five centered at (10, 8). Accordingly, the point (9, 6) is not added to a result set. Additionally, in the y-dimension, this node is 2 units away from the target point of (10, 8). Because this distance is less than the specified minimum of 5 units, both sub-branches are searched. Nodes in the left branch are all further away from the target point 700 (in the y-dimension). Thus, this branch may be searched with a miss-accumulation vector of <0, 2>. This is because by virtue of the design of a kd-tree all nodes in the left sub-branch are guaranteed to be less than 7 in the y-dimension. Stated differently, all nodes in the left sub-branch are at least 2 units away from the target point 700 in the y-dimension.

For the sub-branch to the right of the node (9, 6) the miss-accumulation vector would remain <0, 0>, however, no further nodes are present in our example tree. For the right branch, the point (8, 1) has a distance of 7.2 units from the target. Accordingly, the point (8, 1) is not added to a result set.

Advantageously, embodiments of the invention carry forward a missed distance between a target point and nodes of a kd-tree. Thus, while a given node of the kd-tree is evaluated for a distance between that node using a single splitting dimension, a miss-accumulation vector is used to accumulate distance across multiple dimensions. When the accumulated distance exceeds the specified minimum, entire sub-branches of a kd-tree need not be evaluated, thereby improving the efficiency of a molecular modeling simulation. Because molecular modeling simulations are typically performed a very large number of times for different conformations of even a single ligand and receptor, the effect of reducing the average number of recursive calls to the search function for any individual conformation is highly leveraged and can provide a significant improvement to overall simulation performance

While the foregoing is directed to embodiments of the present invention, other and further embodiments of the invention may be devised without departing from the basic scope thereof, and the scope thereof is determined by the claims that follow.

What is claimed is:

1. A method of performing a computational simulation, comprising:
searching a first kd-tree storing positions of atoms in a first molecule to identify which atoms of the first molecule are within an envelope surrounding a set of atoms in a second molecule, wherein the searching comprises, recursively:
traversing the first kd-tree to a next node of the first kd-tree;
upon determining that a first distance between the node and a target point is less than a specified maximum distance, adding the node to a result set;
determining a second distance, in a splitting dimension, between a dimensional coordinate of the node and a dimensional coordinate of the target point;
upon determining that the second distance is less than the maximum distance, adding the second distance to a miss-accumulation vector, wherein the miss-accumulation vector stores a minimum distance between the target point and nodes in sub-branches of the node across all k-dimensions of the first kd-tree,
upon determining that a distance between the miss-accumulation vector and the target point is greater than the maximum distance, searching only a branch of the first kd-tree closer to the target point in the splitting dimension, and otherwise, searching both a left-sub branch and a right sub-branch of the first kd-tree, and
upon determining that the second distance is greater than the maximum distance, searching the branch of the first kd-tree closer to the target point in the splitting dimension.

2. The method of claim 1, further comprising:
prior to searching the first kd-tree, selecting a conformation for the first molecule and the second molecule to simulate, wherein the conformation includes a set of atoms in the first molecule, a set of atoms in the second molecule, and specifies a position of the first and second molecule, relative to one another; and
defining a region of space for an envelope surrounding the set of atoms in the second molecule, wherein the region of space is defined by the target point and the maximum distance from the target point; and
after searching the first kd-tree for each atom of the first molecule within the envelope surrounding the set of atoms in the second molecule, parsing a second generated kd-tree based on the atoms of the second module to identify a corresponding nearest atom of the second molecule.

3. The method of claim 1, wherein the splitting dimension of the first kd-tree cycles through k-dimensions of the first kd-tree, wherein the left branch from the node includes nodes with coordinate values in the splitting dimension than that of the node and the right branch includes nodes with a coordinate value in the splitting dimension greater than that of the node.

4. The method of claim 1, wherein the envelope is constructed based on the center of mass of the second molecule.

5. The method of claim 1, wherein the envelope is constructed based on the geometric center of the second molecule.

6. The method of claim 5, wherein the radius is equal to the distance from the point representing the center of the envelope to the atom to an atom of the second molecule furthest from the point representing the center of the envelope.

7. The method of claim 1, further comprising, determining, for at least one of the atoms of the first molecule within the envelope surrounding the set of atoms in the second molecule, whether the corresponding nearest atom of the second molecule is within a specified distance.

8. The method of claim 7, further comprising, upon determining that at least one of the atoms of the first molecule is within the specified distance to the corresponding nearest atom of the second molecule, ending the computational simulation for the selected conformation of the first molecule and the second molecule.

9. The method of claim 8, further comprising, upon determining that none of the atoms of the first molecule determined to be within the envelope are also determined to be within the specified distance, simulating the interaction between the first and second molecule to estimate at least one of a binding affinity and a free energy state of the conformation of the first and second molecules.

10. A computer-readable storage medium containing a program which, when executed, performs an operation for performing a computational simulation, the operation comprising:
searching a first kd-tree storing positions of atoms in a first molecule to identify which atoms of the first molecule are within an envelope surrounding a set of atoms in a second molecule, wherein the searching comprises, recursively:
traversing the first kd-tree to a next node of the first kd-tree;
upon determining that a first distance between the node and a target point is less than a specified maximum distance, adding the node to a result set;
determining a second distance, in a splitting dimension, between a dimensional coordinate of the node and a dimensional coordinate of the target point;
upon determining that the second distance is less than the maximum distance, adding the second distance to a miss-accumulation vector, wherein the miss-accumulation vector stores a minimum distance between the target point and nodes in sub-branches of the node across all k-dimensions of the first kd-tree,
upon determining that a distance between the miss-accumulation vector and the target point is greater than the maximum distance, searching only a branch of the first kd-tree closer to the target point in the splitting dimension, and otherwise, searching both a left-sub branch and a right sub-branch of the first kd-tree, and
upon determining that the second distance is greater than the maximum distance, searching the branch of the first kd-tree closer to the target point in the splitting dimension.

11. The computer-readable storage medium of claim 10, wherein the operation further comprises:
prior to searching the first kd-tree, selecting a conformation for the first molecule and the second molecule to simulate, wherein the conformation includes a set of atoms in the first molecule, a set of atoms in the second molecule, and specifies a position of the first and second molecule, relative to one another; and
defining a region of space for an envelope surrounding the set of atoms in the second molecule, wherein the region of space is defined by the target point and the maximum distance from the target point; and
after searching the first kd-tree for each atom of the first molecule within the envelope surrounding the set of atoms in the second molecule, parsing a second generated kd-tree based on the atoms of the second module to identify a corresponding nearest atom of the second molecule.

12. The computer-readable storage medium of claim 10, wherein the splitting dimension of the first kd-tree cycles through k-dimensions of the first kd-tree, wherein the left branch from the node includes nodes with coordinate values in the splitting dimension than that of the node and the right branch includes nodes with a coordinate value in the splitting dimension greater than that of the node.

13. The computer-readable storage medium of claim 10, wherein the envelope is constructed based on the center of mass of the second molecule.

14. The computer-readable storage medium of claim 10, wherein the envelope is constructed based on the geometric center of the second molecule.

15. The computer-readable storage medium of claim 14, wherein the radius is equal to the distance from the point representing the center of the envelope to the atom to an atom of the second molecule furthest from the point representing the center of the envelope.

16. The computer-readable storage medium of claim 10, wherein the operation further comprises, determining, for at least one of the atoms of the first molecule within the envelope surrounding the set of atoms in the second molecule, whether the corresponding nearest atom of the second molecule is within a specified distance.

17. The computer-readable storage medium of claim 16, wherein the operation further comprises, upon determining that at least one of the atoms of the first molecule is within the specified distance to the corresponding nearest atom of the second molecule, ending the computational simulation for the selected conformation of the first molecule and the second molecule.

18. The computer-readable storage medium of claim 17, wherein the operation further comprises, upon determining that none of the atoms of the first molecule determined to be within the envelope are also determined to be within the specified distance, simulating the interaction between the first and second molecule to estimate at least one of a binding affinity and a free energy state of the conformation of the first and second molecules.

19. A computing device, comprising:
a compute node having at least a processer and a memory; and
a simulation program, which when executed by the compute node, performs an operation, the operation comprising:
searching a first kd-tree storing positions of atoms in a first molecule to identify which atoms of the first molecule are within an envelope surrounding a set of atoms in a second molecule, wherein the searching comprises, recursively:
traversing the first kd-tree to a next node of the first kd-tree;
upon determining that a first distance between the node and a target point is less than a specified maximum distance, adding the node to a result set;
determining a second distance, in a splitting dimension, between a dimensional coordinate of the node and a dimensional coordinate of the target point;
upon determining that the second distance is less than the maximum distance, adding the second distance to a miss-accumulation vector, wherein the miss-accumulation vector stores a minimum distance between the target point and nodes in sub-branches of the node across all k-dimensions of the first kd-tree,
upon determining that a distance between the miss-accumulation vector and the target point is greater than the maximum distance, searching only a branch of the first kd-tree closer to the target point in the splitting dimension, and otherwise, searching both a left-sub branch and a right sub-branch of the first kd-tree, and
upon determining that the second distance is greater than the maximum distance, searching the branch of the first kd-tree closer to the target point in the splitting dimension.

20. The computing device of claim 19, wherein the operation further comprises:
prior to searching the first kd-tree, selecting a conformation for the first molecule and the second molecule to simulate, wherein the conformation includes a set of atoms in the first molecule, a set of atoms in the second molecule, and specifies a position of the first and second molecule, relative to one another; and
defining a region of space for an envelope surrounding the set of atoms in the second molecule, wherein the region of space is defined by the target point and the maximum distance from the target point; and
after searching the first kd-tree for each atom of the first molecule within the envelope surrounding the set of atoms in the second molecule, parsing a second generated kd-tree based on the atoms of the second module to identify a corresponding nearest atom of the second molecule.

21. The computing device of claim 19, wherein the splitting dimension of the first kd-tree cycles through k-dimensions of the first kd-tree, wherein the left branch from the node includes nodes with coordinate values in the splitting dimension than that of the node and the right branch includes nodes with a coordinate value in the splitting dimension greater than that of the node.

22. The computing device of claim 19, wherein the envelope is constructed based on the center of mass of the second molecule.

23. The computing device of claim 19, wherein the envelope is constructed based on the geometric center of the second molecule.

24. The computing device of claim 23, wherein the radius is equal to the distance from the point representing the center of the envelope to the atom to an atom of the second molecule furthest from the point representing the center of the envelope.

25. The computing device of claim 19, further comprising, determining, for at least one of the atoms of the first molecule within the envelope surrounding the set of atoms in the second molecule, whether the corresponding nearest atom of the second molecule is within a specified distance.

26. The computing device of claim 25, wherein the operation further comprises, upon determining that at least one of the atoms of the first molecule is within the specified distance to the corresponding nearest atom of the second molecule, ending the computational simulation for the selected conformation of the first molecule and the second molecule.

27. The computing device of claim 26, wherein the operation further comprises, upon determining that none of the atoms of the first molecule determined to be within the envelope are also determined to be within the specified distance, simulating the interaction between the first and second molecule to estimate at least one of a binding affinity and a free energy state of the conformation of the first and second molecules.
